(19) United States
(12) Patent Application Publication
(10) Pub. No.: US 2013/0303663 A1
(43) Pub. Date: Nov. 14, 2013

(54) POLYMER COMPRISING A HYDROLYSABLE FUNCTION THAT CAN BE USED AS A THINNER

(71) Applicants: Mathias Agnely, Bourg-La-Reine (FR); Pascal Boustingorry, Breuillet (FR); Kamel Chougrani, Loury (FR)

(72) Inventors: Mathias Agnely, Bourg-La-Reine (FR); Pascal Boustingorry, Breuillet (FR); Kamel Chougrani, Loury (FR)

(73) Assignee: CHRYSO, Issy Les Moulineaux (FR)

(21) Appl. No.: 13/995,685

(22) PCT Filed: Dec. 20, 2011
(86) PCT No.: PCT/EP2011/073446

§ 371 Date: Aug. 2, 2013

(30) Foreign Application Priority Data
Dec. 21, 2010 (FR) 1060920

(51) Int. Cl. C04B 24/26

(52) U.S. Cl. CPC C04B 24/2694
USPC 524/5; 526/266; 524/548

(57) ABSTRACT

The invention relates to a polymer comprising the following units:

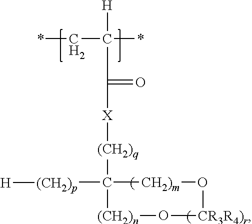

and the side chains comprising R₂ groups,
to its preparation methods and to its uses as a thinner in hydraulic compositions.

The present invention relates to a polymer, its preparation method and its uses as a thinner in hydraulic compositions.

### PRIOR ART

The hydraulic compositions are compositions comprising a hydraulic binder. A hydraulic binder is a binder which forms and hardens by chemical reaction with water. As hydraulic binders, mention may be made of compositions of plasters, calcium sulfates and aluminates, lime and cement. Mortars and concretes, especially precast concretes and ready-to-use concretes are of particular significance. These materials may especially be intended for buildings, civil engineering structures or for precasting.

The addition to hydraulic binders of thinners (also called plasticizers or super plasticizers), which allow the hydraulic composition to be thinned and thus a reduction in the water content of the hydraulic binder paste, is known. Thus, the hydraulic binder paste has, after hardening, a denser structure. This is expressed by higher mechanical strength.

Polyoxyalkylene polycarboxylates (PCP) are especially known to be particularly effective for thinning hydraulic compositions and are also called super-plasticizers.

Recently, thinners have been developed with which improved fluidity of hydraulic compositions may be maintained over time. Thinners having a structure changing over time in fresh concrete have been developed. These thinners are comb polymers for which the side chains include ester functions, which are hydrolyzed under basic conditions prevailing in hydraulic compositions by releasing carboxylate functions over time. These carboxylate functions may be adsorbed on the hydraulic binder grains, especially of cement, which induces repulsion between the grains and thus gives the possibility of maintaining good fluidity of the composition over time. Such thinners are especially described in US 2002/0007019 (Schober and al.), WO 2004/099099 (Nippon Shokubai) and EP 0 846 090 (Kao corporation).

### TECHNICAL PROBLEM

One of the goals of the invention is to provide compounds which are useful as thinners allowing both improvement in maintaining fluidity of hydraulic compositions over time, which are more effective than the thinners of the prior art, and inhibiting the formation of cracks in the hardened hydraulic composition.

### DESCRIPTION OF THE INVENTION

### [Polymer]

According to a first aspect, the invention relates to a polymer comprising a main chain comprising units of formulae (A):

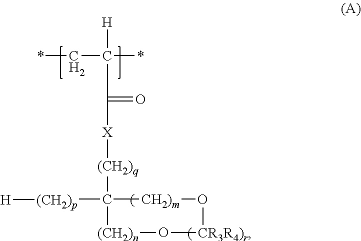

and side chains comprising R₂ groups,
wherein:
X represents O or NH,
R₂ represents a group (R₇O)_{z}R₈, with:
   R₇ represents a C₂-C₃ alkylene group,
   R₈ represents H, a C₁-C₁₂ alkyl, a cycloalkyl or an aryl which are optionally substituted, and
   z represents an integer from 1 to 250,
m, n, p and q represent independently an integer comprised between 0 and 3,
r represents an integer comprised between 1 and 3,
R₃ and R₄ represent independently H or a C₁-C₆ alkyl group.

The polymer according to the invention comprises side chains comprising R₂ groups. Each R₂ group may be bound to the main chain of the polymer through:
a single bond (the polymer may for example comprise vinyl groups bearing an R₂ group),
a methylene group (the polymer may for example comprise allyl groups bearing an R₂ group),
an amide function,
an ester function (the polymer may for example have (alkyl)acrylate groups bearing an R₂ group).

Generally, the R₂ groups are bound to the main chain of the polymer through ester functions, and the polymer typically comprises units of the following formulae (A) and (B):

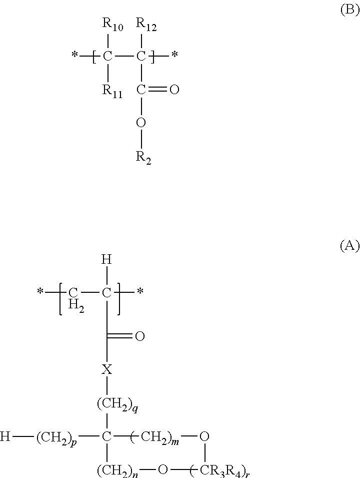

wherein:
X represents O or NH,
R₂ represents a group (R₇O)_{z}R₈, with:
   R₇ represents a C₂-C₃ alkylene group,
   R₈ represents H, a C₁-C₁₂ alkyl or a cycloalkyl, or an aryl, optionally substituted, and
   z represents an integer from 1 to 250,
m, n, p and q represent independently an integer comprised between 0 and 3,
r represents an integer comprised between 1 and 3,
R₃ and R₄ represent independently H or a C₁-C₆ alkyl group,
R₁₀, R₁₁ and R₁₂ represent independently a group selected from H, alkyl, —COO-alkyl, COOR₂ and COO(M)_{1/c} wherein M represents a cation and c is an integer representing the valency of the cation M.

Advantageously, the hydraulic compositions comprising the aforementioned polymers exhibit good maintaining of the fluidity over time, generally up to one hour, or even more than two hours, after mixing the components of the hydraulic composition. It is considered that fluidity is maintained when the spreading value of the composition is reduced by at least 50%, especially by at least 30%, preferably by at least 10% relatively to its initial value, just before preparing the hydraulic composition.

The polymer according to the invention has a structure which changes over time when it is added into hydraulic compositions. Indeed, the units of formula (A) are slowly hydrolyzed under the basic conditions prevailing in hydraulic compositions, thus releasing carboxylate functions. These carboxylate functions may be adsorbed on the hydraulic binder grains, that which is supposed to contribute to maintaining good fluidity of the hydraulic composition over time. This is referred to as “hydrolysable unit” stemming from a “hydrolysable monomer”.

In addition to the units of formula (A) and to the side chains comprising groups of formula (R₇O)_{z}R₈, the polymer may contain one or several units stemming from monomers selected from the following monomers:
an ionic or ionizable monomer of the phosphonic, sulfonic, or carboxylic type. A phosphoethyl methacrylate or a polyethylene glycol phosphate ester monomethacrylate, such as the monomers of the Sipomer PAM range marketed by Rhodia, are examples of phosphonic monomers. Vinyl sulfonic acid and its salts, styrene sulfonic acid and its salts, 2-acrylamido-3-methylpropane sulfonic acid and its salts, allyoxyhydroxypropyl sulfonic acid and its salts, and methallylsulfonic acid and its salts may be used as sulfonic monomers. Acrylic acid, methacrylic acid, maleic acid, fumaric acid, itaconic acid, crotonic acid are examples of carboxylic monomers.
a monomer comprising a polyalkylene glycol group, especially polyethylene glycol (PEG), for example:
   polyalkylene glycol (meth)acrylate, especially polyethylene glycol (PEG) methacrylate, monomers of the PEG acrylate type being advantageously used because of their hydrolysable nature in hydraulic compositions;
   polyalkylene glycol maleate, especially polyethylene glycol maleate;
   polyalkylene glycol vinyl ether, especially polyethylene glycol vinyl ether, or
   polyalkylene glycol allyl, especially polyethylene glycol allyl, in particular polyethylene glycol methyl ether allyl (of formula CH═CH—CH₂-(o—CH₂—CH₂)ₙ—OMe), the molecular weight of which is for example comprised between 100 and 10,000, preferably between 350 and 7,000 and advantageously between 350 and 5,000; and/or
a hydrolysable monomer such as PEG acrylate or alkyl-PEG ether acrylate, acrylamide and its derivatives, acrylonitrile and its derivatives, alkyl acrylate such as ethyl acrylate, hydroxyalkyl acrylate such as hydroxyethyl acrylate, vinyl esters of carboxylic acids such as vinyl acetate, copolymerizable carboxylic anhydrides such as maleic anhydride or methacrylic anhydride, monomers with imide functions such as maleimide and its derivatives.
a non-hydrolysable monomer, such as styrene, alkyl methacrylate like methyl methacrylate.

The aforementioned monomers are introduced into the polymer by copolymerization (incorporation into the main chain) or by post-functionalization, especially by post-esterification (incorporation into the side chains). The preparation methods are described hereafter.

The hydrolysable monomers (including the monomers corresponding to the units of formula (A)) generally represent from 5% to 95% molar of the whole of the applied monomers, preferably from 10% to 60% molar of the whole of the applied monomers.

Preferably, X represents O. Indeed, when X represents O, the side chain bearing

the group

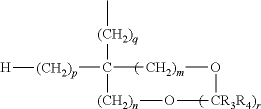

is bound to the main chain through an ester function, which generally hydrolyzes easier than an amide function (when X represents NH) in order to form carboxylate functions, which give the possibility of maintaining good fluidity of the hydraulic composition (as explained below).

Typically, R₁₀, R₁₁ and R₁₂ represent H or an alkyl. Preferably, R₁₀ and R₁₁ represent H and R₁₂ represents a methyl.

In a preferred embodiment, the polymer comprises the units of the following formulae (A), (B) and (C):

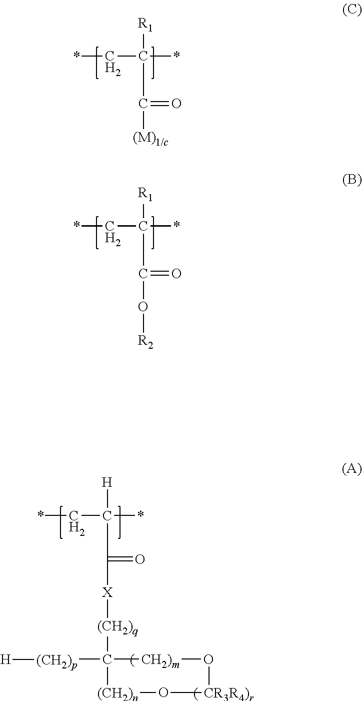

wherein:
X represents O or NH,
R₁ represents H or a methyl,
R₂ represents a group (R₇O)_{z}R₈, with:
   R₇ represents a C₂-C₃ alkylene group,
   R₈ represents H, a C₁-C₁₂ alkyl or cycloalkyl, or an aryl, optionally substituted, and
   z represents an integer from 1 to 250,
m, n, p and q represent independently an integer comprised between 0 and 3,
r represents an integer comprised between 1 and 3,
R₃ and R₄ represent independently H or a C₁-C₆ alkyl group,
M represents H or a cation and c is an integer representing the valency of the cation M.

Preferably the polymer consists in a chained sequence of the three aforementioned units without incorporation of any other units, and therefore has the following formula (I):

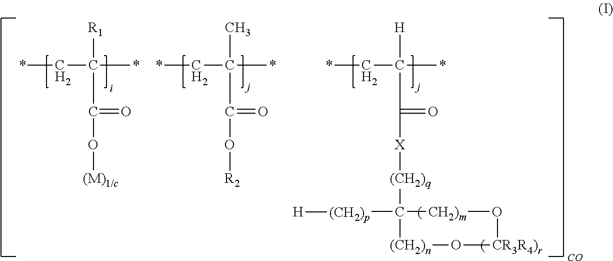

wherein:
i, j and k represent independently an integer from 1 to 1,000,
M, X, c, R₁, R₂, R₃, R₄, m, n, p, q and r, are as defined above.

Within the scope of this discussion, by “polymer” is meant a compound comprising the covalent chained sequence of monomeric patterns (or units), either identical or different from each other, generally of more than 10 monomeric units typically of more than 100 monomeric units. A copolymer comprises a covalent chained sequence of at least two types of different units.

Within the scope of this discussion, by “side chain” or “pendant chain”, are meant a chain covalently bound to the main chain of the polymer. For example, the groups COOR₂ and

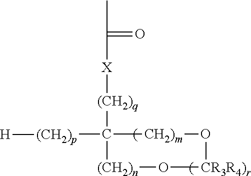

are side chains of the polymer of the formula (I).

Within the scope of this discussion and unless specified otherwise, by “hydrocarbon chain” is meant a chain comprising one or several carbon atoms and one or several hydrogen atoms, this chain being functionalized or non-functionalized, linear, branched or cyclic, saturated or unsaturated. The hydrocarbon chains present within a polymer according to the invention preferably comprise from 1 to 12 carbon atoms, preferably less than 6 carbon atoms.

Within the scope of this discussion and unless specified otherwise, the alkyl groups represent monovalent saturated hydrocarbon chains, with a linear or branched or cyclic chain (for example a cyclohexyl radical) from 1 to 12 carbon atoms, preferably from 1 to 6 carbon atoms. As examples of alkyl radicals, mention may especially be made:
when they are linear, of methyl, ethyl, propyl, butyl, pentyl, hexyl, octyl, nonyl, decyl, dodecyl, tetradecyl, hexadecyl, and octadecyl radicals,
when they are branched, of isopropyl, s-butyl, isobutyl et t-butyl groups.

Within the scope of this discussion, and unless specified otherwise, the alkylene radicals represent divalent saturated hydrocarbon radicals, with a linear or branch chain, from 1 to 10 carbon atoms, preferably from 1 to 6 carbon atoms. Methylene, ethylene and propylene radicals are more preferred.

Within the scope of this discussion, and unless specified otherwise, the aryl radicals represent mono- or bi-cyclic hydrocarbon aromatic systems from 6 to 10 carbon atoms. Among the aryl radicals, mention may especially be made of the phenyl or naphthyl radical.

The alkyl, cycloakyl and/or aryl groups are often substituted with one or several halogen groups, especially fluorine, chlorine or bromine atoms, alkyl groups, especially methyl or alkoxy, especially, methoxy.

A cation is an ion bearing a positive charge. Ammonium or metal, especially alkaline metal or alkaline earth metal cations are preferred. Alkaline metal cations are Li⁺, Na⁺, K⁺ and Cs⁺. Alkaline earth metal cations are preferably Ca²⁺ and Mg²⁺. An ammonium cation is a cation including a nitrogen atom bearing a positive charge. The ammonium cation either corresponds:
to the protonated form of an amine function, which may be a primary, secondary, tertiary or aromatic amine,
or to a quaternary ammonium cation, for example a tetraalkylammonium cation.

By the index “co”, is meant that the arrangement of the consecutive units of the polymer is not specified. The arrangement of the units and the polymer may for example be with blocks, either alternating, random or with a composition gradient.

By “*” is meant that the different units may be assembled to each other in any order, each unit being generally assembled from head to tail.

The following preferential embodiment may be applied in a combined or independent way:
X represents O,
R₇ represents an ethylene group,
R₈ represents H, or a C₁-C₁₂alkyl, especially a methyl or an ethyl,
z represents an integer between 8 and 230, especially between 15 and 115, typically 108,
R₂ is a group —(CH₂—CH₂—O)₁₀₈-Me, which may be obtained by esterification with a poly(ethylene glycol) methyl ether with a molecular weight of 4750 g/mol (MPEG 4750),
i, j and k represent independently an integer comprised between 1 and 100,
q represents 0 or 1, in particular 1,
p represents 0, 1 or 2, in particular 2,
m represents 1,
n represents 1,
r represents 1,
R₃ and R₄ represent independently H, a methyl or an ethyl, preferably H,
the ratio i/(i+j+k) is from 0.01 to 0.8, especially from 0.01 to 0.2, in particular from 0.02 to 0.05,
the ratio j/(i+j+k) is from 0.01 to 0.65, especially from 0.2 to 0.5,
the ratio k/(i+j+k) is from 0.05 to 0.90, especially from 0.3 to 0.7.

Generally the polymer comprises from 2 to 20% by mass, typically from 2 to 10% by mass of a unit of formula (A).

Preferably, the weight molecular mass of the polymer is from 5,000 to 500,000 g/mol.

Preferably, the polymer according to the invention has the following formula (I′):

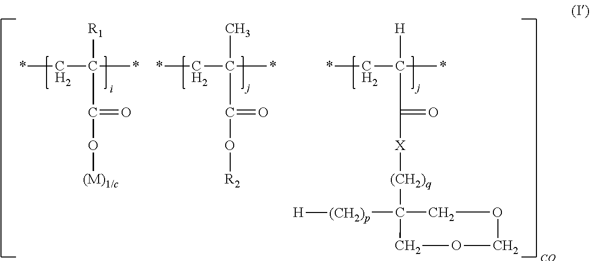

wherein X, R₁, R₂, M, c, i, j, k, p and q are as defined above.

Preferably, the polymer according to the invention has the following formula (I″):

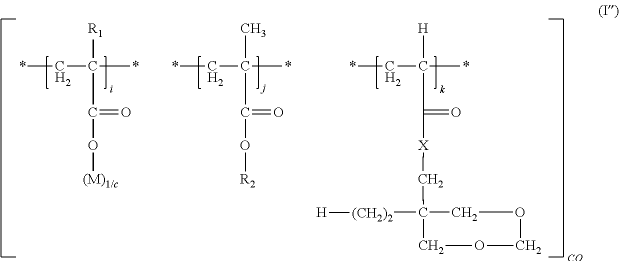

wherein X, R₁, R₂, M, c, i, j and k are as defined above.

### [Preparation Method]

According to a second aspect, the invention relates to a method for preparing a polymer as defined above, comprising a step a1) for copolymerization of a monomer of the following formula (XII):

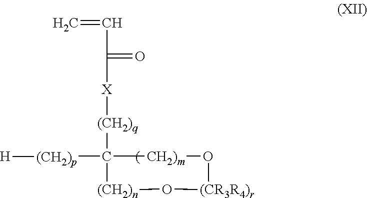

wherein X, R₃, R₄, m, n, p, q and r are as defined above,
with a monomer of the following formula (XI′):

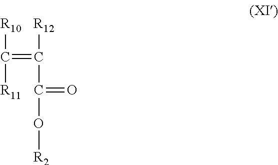

wherein R₂, R₁₀, R₁₁ and R₁₂ are as defined above.

The alkene functions of both monomers react together in order to form the main chain of the polymer. The side chains of the formed polymer especially comprise groups of formulae COOR₂ and

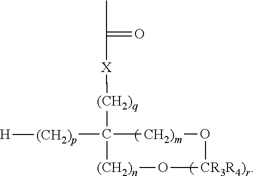

Other monomers may be added during the copolymerization step a1), especially those mentioned above, like ionic or ionizable monomers of the phosphonic, sulfonic or carboxylic type, the monomers comprising a polyalkylene glycol group, hydrolysable monomers and/or non-hydrolysable monomers. The preparation of the polymers is accomplished according to conditions known to one skilled in the art, especially by following the procedures described in patent FR 2 892 420.

With the preparation method it is especially possible to prepare the polymer comprising the units of the following formulae:

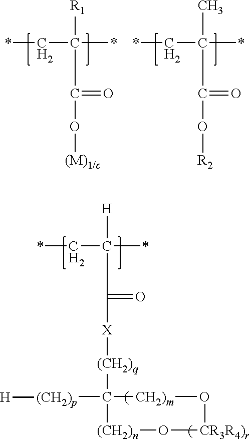

by applying polymerization of the monomers corresponding to the sought units or of their precursors if necessary.

The method for preparing this polymer preferably comprises a step a1) for copolymerization of monomers of the following formulae (X), (XI) and (XII):

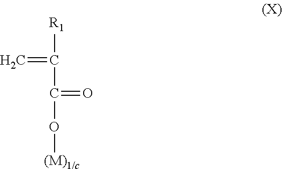

wherein R₁, M and c are as defined above,

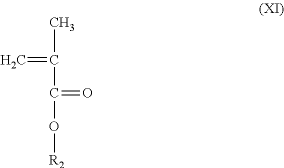

wherein R₂ is as defined above,

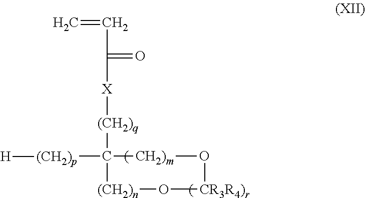

wherein X, R₃, R₄, m, n, p, q and r are as defined above.

Preferably, the monomer (XII) applied in step a1) has the following formula (XII′):

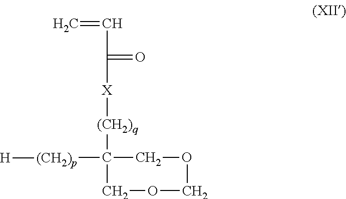

wherein X, p and q are as defined above, and in particular the following formula (XII″):

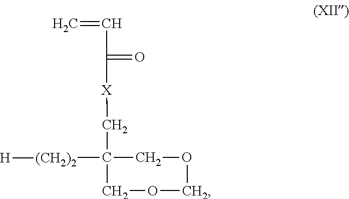

wherein X represents O or NH, preferably O, which then corresponds to the cyclic trimethylolpropane formaldehyde acrylate, which is advantageously available commercially.

In another embodiment, the method for preparing the polymer comprises the steps of:

a2) copolymerizing a monomer of the following formula (XXII):

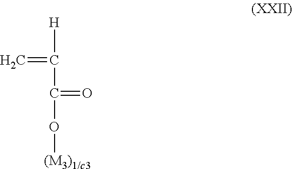

wherein M₃ represents H, a metal cation or an ammonium cation and c3 is an integer representing the valency of the cation M₃,
with a monomer of the following formula (XXI′):

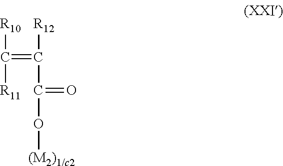

wherein R₁₀, R₁₁ and R₁₂ are as defined above, M₂ represents H, a metal cation or an ammonium cation and c2 is an integer representing the valency of the cation M₂,
b) esterification of the polymer obtained during step a2) with compounds R₂-GP₁ and

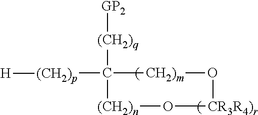

wherein R₂, R₃, R₄, m, n, p, q and r are as defined above and GP₁ and GP₂ are leaving groups, especially independently selected from —OH, —OTs (tosylate), OMs (mesylate), —Cl and —Br.

In particular, the method comprises the steps of:

a2) copolymerizing monomers of the following formulae (X), (XXI) and (XXII):

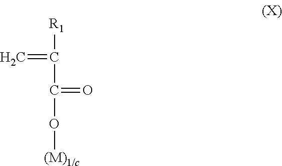

wherein R₁, M and c are as defined above,

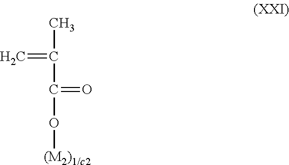

wherein M₂ represents H, a metal cation or an ammonium cation and c2 is an integer representing the valency of the cation M₂,

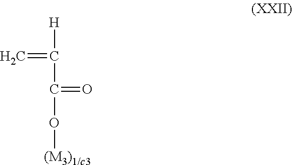

wherein M₃ represents H, a metal cation or an ammonium cation and c3 is an integer representing the valency of the cation M₃,
in order to obtain a polymer (XXV) comprising units of the following formulae:

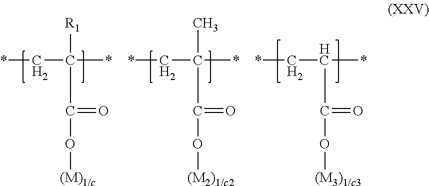

b) esterification of the polymer (XXV) with compounds P₂-GP₁ and

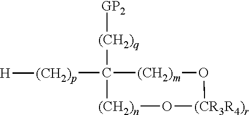

wherein R₂, R₃, R₄, m, n, p, q and r are as defined above and GP₁ and GP₂ are leaving groups, especially independently selected from —OH, —OTs, OMs, —Cl and —Br.

During step b), the compounds of R₂-GP₁ (or GP₁—(R₇O)_{z}R₈) and

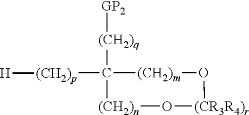

react in a non-regioselective way with carboxylic or carboxylate functions, which leads to random grafting of the groups R₂ and

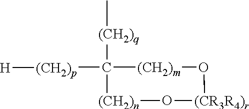

on the carboxylate or carboxylic functions of the polymer obtained at the end of step a2), especially of formula (XXV). Therefore, the mixture of polymers obtained at the end of step b) comprises the polymer as defined above. Thus, the first embodiment of the method (comprising step a1)) is preferred since it gives the possibility of obtaining the polymer with improved purity as compared with the second embodiment.

Preferably, the copolymerization step is carried out by radical polymerization, typically in the presence of an initiator and a transfer agent.

The initiator is for example hydrogen peroxide, an oxidation-reduction pair, the oxidizing agent especially being ammonium persulfate and the reducing agent especially being metabisulfite of an alkylene metal, for example sodium, or a water-soluble azoic initiator such as for example 2,2′-azobis(2-amidinopropane) dihydrochloride or 2,2′-azobis(2-methylpropionamide) dihydrate.

The transfer agent may especially be sodium methallyl sulfonate, 2-mercaptoethanol, mercaptoacetic acid, mercaptosuccinic acid or alkyl mercaptan.

The method may be carried out batchwise or in a semi-continuous way, and is preferably a semi-continuous method.

During polymerization the pH is generally adjusted between 1 and 3, preferably of the order of 2, according to methods known to one skilled in the art.

The temperature during polymerization is generally 40 to 80° C., preferably from 60 to 70° C.

Preferably, the preparation method described above do not apply lower alkyl acrylate monomers (especially methyl or ethyl acrylate) or lower hydroxyalkyl acrylate monomers, (especially 2-hydroxyethyl acrylate) unlike the methods for preparing certain thinners of the prior art. These monomers are delicate to use because of their low flash point (close to 2° C. and 15° C. for methyl and ethyl acrylate) or of their toxicity in the case of 2-hydroxyethyl acrylate. Further the corresponding released alcohols are volatile (VOC) in the case of methanol and ethanol and/or toxic in the case of ethylene glycol and of methanol. The monomers used in the preparation methods according to the invention are advantageously not very toxic and have high flash points, which is advantageous in terms of safety.

### [Uses]

According to a third aspect, the invention relates to the use of the polymer as defined above as a thinner (or plasticizer) for hydraulic compositions, especially for improving the maintaining of fluidity of hydraulic compositions over time, generally for up to one hour, or even more than two hours, after mixing the components of the hydraulic composition and for inhibiting the formation of cracks in the hardened hydraulic composition.

Without intending to be bound by a particular theory, good maintenance of fluidity may be explained by the specific structure of the polymers according to the invention, which changes over time in the hydraulic composition, which is an alkaline medium generally with a pH comprising 11 and 13.

Indeed, under these conditions, gradual hydrolysis of the ester side functions (X represents O) or amide side functions (X represents NH) of the unit of formula (A) is observed:

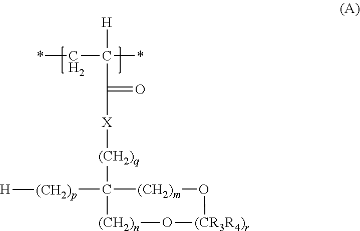

in the hydraulic composition which generates over time:
carboxylate functions on the polymer, which may be adsorbed on the hydraulic binder grains, thereby generating repulsion between the grains and thus giving the possibility of maintaining good fluidity of the hydraulic composition,
an alcohol (X represents O) or an amine (X represents NH) of the following formula

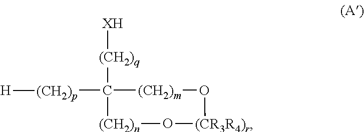

wherein X, m, n, p, q and r are as defined above
   according to the scheme 1 below.

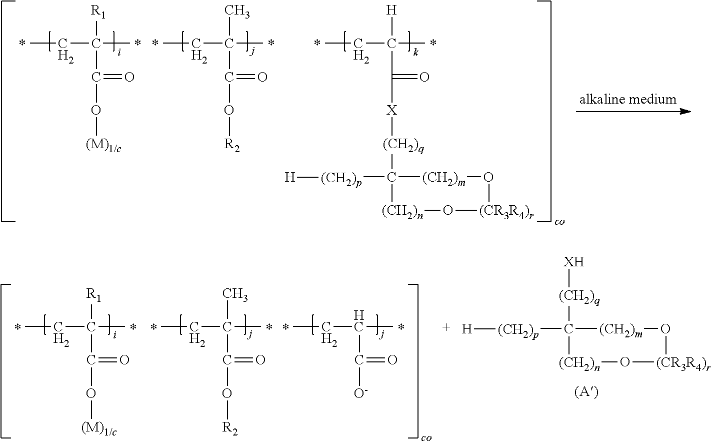

The compound of formula (A′), especially when X represents O, in particular 5-ethyl-5-hydroxymethyl-1,3-dioxane, advantageously gives the possibility of avoiding the formation of cracks in hardened hydraulic compositions, as described in patent U.S. Pat. No. 6,251,180. Therefore there is a dual effect of the polymer according to the invention:
improvement in the maintainance of fluidity of the hydraulic composition over time,
inhibition of the formation of cracks in hardened hydraulic compositions.

On the other hand, the ester function of the unit of formula (B):

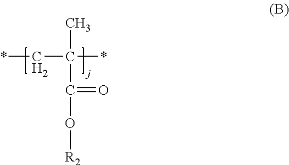

is stable in an alkaline medium. It is therefore possible to modulate the hydrolysis of the polymer by varying the respective content of the different units in the polymer.

It has been demonstrated that maintaining the fluidity of a hydraulic composition comprising as an admixture a polymer according to the invention is improved as compared with that of a hydraulic composition comprising as an admixture a polymer without hydrolysable side ester functions, especially of the following formula (W):

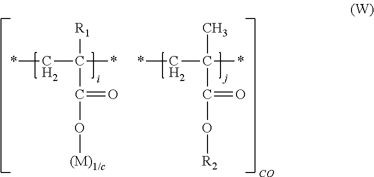

wherein R₁, R₂, M, c, i and j are as defined above.

Further, it has been demonstrated that maintaining the fluidity of a hydraulic composition comprising as an admixture a polymer according to the invention is improved as compared with that of a hydraulic composition comprising as an admixture a polymer comprising units bearing hydrolysable side ester functions of the poly(ethylene glycol) alkyl ether ester type of the following formula:

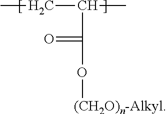

According to a fourth aspect, the invention relates to the use of a polymer as defined above for preparing a hydraulic composition comprising:
a polymer as defined above,
a hydraulic binder,
at least one granulate, and
water.

The hydraulic compositions may especially be concrete, mortar or plaster.

The hydraulic compositions are conventionally prepared by mixing the aforementioned constituents. The invention also relates to the method for preparing a hydraulic composition comprising the step for mixing:
a polymer as defined above,
a hydraulic binder,
at least one granulate,
water,
the components being added in any order.

The polymer according to the invention may be added to the other components of the dry hydraulic composition (generally as a powder) or as a solution, preferably an aqueous solution. Thus, according to another aspect, the invention relates to a thinner (or plasticizer) for hydraulic compositions comprising the polymer as defined above in solution in a solvent, especially in an aqueous solution, preferably from 5 to 50% by weight of polymer, especially from 10 to 30% by weight, in particular of the order of 20% by weight based on the total weight of the solution. The water of said aqueous solution may especially be a pre-wetting water. By “pre-wetting water”, is meant a portion of the total water, which is used for humidifying the granulates before the mixing allowing simulation of the hygrometric condition of the granules, often humid, in a concrete factory or on a building site. Said aqueous solution comprising the polymer may optionally comprise other additives, for example an antifoam agent, an anti-airflow additive, a setting accelerator or retardant, a rheology modifier, another thinner (plasticizer or super plasticizer) and/or any other additive conventionally used in hydraulic compositions. In a preferred embodiment, said aqueous solution comprising the polymer comprises a thinner especially a superplasticizer, for example a superplasticizer CHRYSO®Fluid Premia 180 or CHRYSO®Fluid Premia 196.

By “granulates” is meant an assembly of mineral grains with an average diameter of between 0 and 125 mm. According to their diameter, the granulates are classified in one of the six following families: fillers, fine sands, sands, gravel and sand mixtures, grit and ballast (standard XP P 18-545). The most used granulates are the following:
fillers, which have a diameter of less than 2 mm and for which at least 85% of the granulates have a diameter of less than 1.25 mm and at least 70% of the granulates have a diameter of less than 0.063 mm,
sands with a diameter comprising 0 and 4 mm (in the standard 13-242, the diameter may range up to 6 mm),
gravel-sand mixtures with a diameter greater than 6.3 mm,
grit with a diameter comprised between 2 mm and 63 mm.
Sands are therefore comprised in the definition of granulate according to the invention. The fillers may especially be of limestone or dolomite origin.

During the mixing step, other additives may be added, for example mineral addition and/or additives, for example an anti-airflow additive, an anti-foam agent, a setting accelerator or retardant, a rheology modifier, another thinner (plasticizer or super plasticizer), especially a superplasticizer, for example a superplasticizer CHRYSO®Fluid Premia 180 or CHRYSO®Fluid Premia 196.

By “mineral addition”, is meant a finely divided mineral material used in concrete in order to improve certain properties or to give it particular properties. The standard NF EN 206-1 distinguishes two types of mineral additions: quasi inert additions (of type I) and additions with latent pozzolanic or hydraulic nature (of type II).

The additions of type I are:
limestone fillers, according to EN 12620:2000
pigments, according to EN 12878
limestone additions, according to the standard NF P 18-508
siliceous additions according to the standard NF P 18-509

The additions of type II group:
flying ashes, according to the standard NF EN 450
silica fumes, according to En 13263-1

Generally, 0.1 to 3%, especially between 1.0 and 2.0%, by dry extract weight, of polymer according to the invention are used in the hydraulic composition.

According to a fifth aspect, the invention relates to a hydraulic composition comprising:
a polymer according to invention as defined above,
a hydraulic binder,
a granulate,
water.

The hydraulic composition may further comprise the aforementioned additives.

The invention also relates to a method for improving maintaining of fluidity over time of a hydraulic composition comprising a step consisting of putting a hydraulic composition or a constituent of a hydraulic composition in contact with a polymer as defined above. The constituents of a hydraulic composition are especially those mentioned above.

### FIGURE

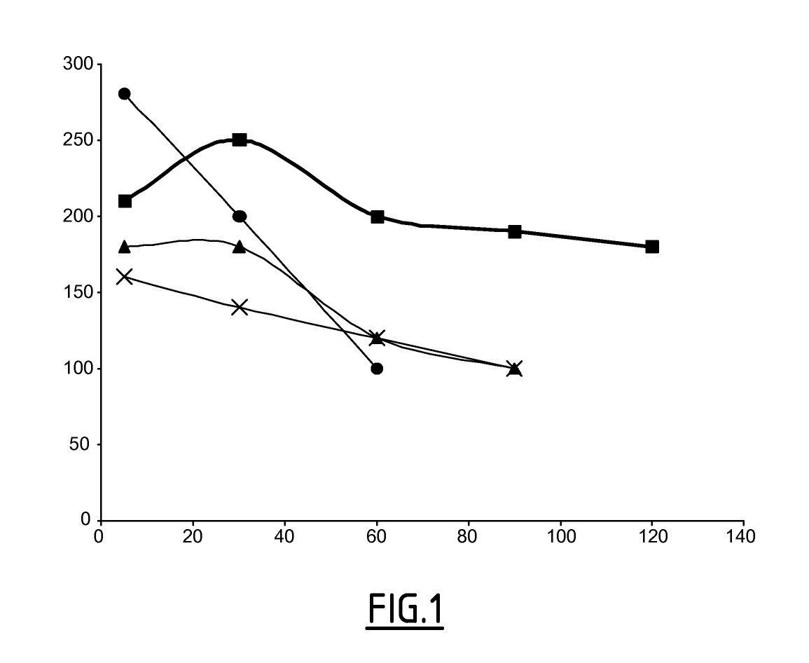

The appended FIG. 1 represents the spreading in millimeters versus time in minutes of mortar compositions of example 2 comprising:
either the polymer (A) of the comparative example (circles),
or polymers (C1) and (C2) of the comparative example 2 (triangles and crosses respectively),
or polymer (B) according to the invention of example 1 (squares).

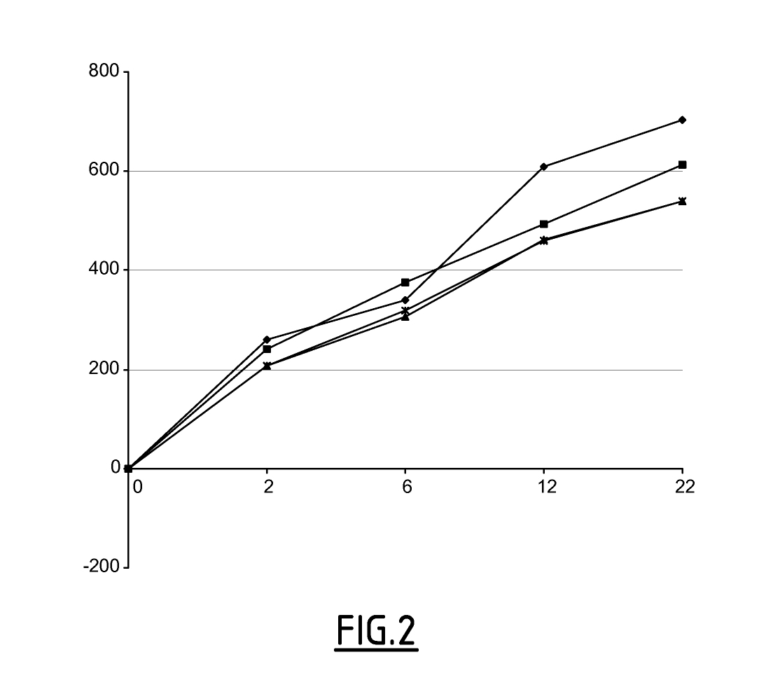

The appended FIG. 2 represents the shrinkage in μm/m versus time in days of mortar compositions of Example 4 comprising:
either no admixture (XXX),
or 0.5% by dry weight of 5-ethyl-5-hydroxymethyl-1,3-dioxane alcohol (XXX),
or 1% by dry weight of 5-ethyl-5-hydroxymethyl-1,3-dioxane alcohol (XXX),
or 3% by dry weight of polymer (B) according to invention of example 1 (XXX).

### EXAMPLE

### Comparative Example

### Synthesis of a Polymer of Formula (A) without any Hydrolysable side chain

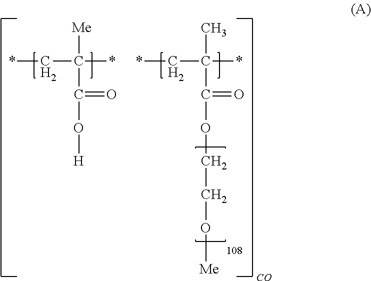

In a glass reactor, equipped with mechanical stirring and a condenser, an aqueous solution (231 g) containing a mixture of sodium methallyl sulfonate (1.4 g) (ALTICHEM) and of sodium metabisulfite (3.1 g) (ALTICHEM) were introduced into the tank bottom. The pH of the mixture was adjusted to 2 by moderate addition of 96% sulfuric acid (0.4 g) (ALTICHEM). The mixture was maintained under strong stirring and with strong nitrogen bubbling for one hour and brought to a temperature of 65° C. Next, and in parallel, an aqueous solution (100 g) containing ammonium persulfate (3.7 g) (ALTICHEM) and a solution containing MPEG 4750 methacrylate (642.1 g) (CHRYSO) and methacrylic acid (18.5 g) (EVONIK) were added. The addition times were three hours for the mixture of monomers and four hours for the ammonium persulfate solution. After one hour of stirring at 65° C., the reaction mixture was cooled to 20° C. and diluted in water in an amount of 20% of dry extract.

### Comparative Example 2

### Synthesis of Polymers of Formulae (C1) and (C2) Including a Hydrolysable Side Chain of the Poly(Ethylene Glycol) Alkyl Ether Ester Type

Polymer (C1) comprising a hydrolysable side chain of the MPEG 350 acrylate type

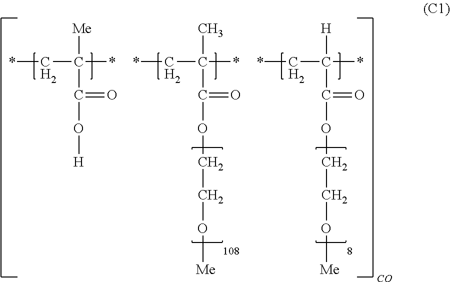

In a glass reactor, equipped with mechanical stirring and a condenser, an aqueous solution (350 g) containing a mixture of sodium methallyl sulfonate (1.14 g) (ALTICHEM) and of sodium metabisulfite (1.72 g) (ALTICHEM) were introduced into the tank bottom. The pH of the mixture was adjusted to 2 by a moderate addition of 96% sulfuric acid (0.9 g). The mixture was maintained under strong stirring and with strong nitrogen bubbling for one hour and brought to a temperature of 65° C. Next, and in parallel, an aqueous solution (100 g) containing ammonium persulfate (1.3 g) (ALTICHEM) and a solution containing MPEG 4750 methacrylate (506 g) (CHRYSO), methacrylic acid (1.6 g) (EVONIK) and MPEG 350 acrylate (47.4 g) (Sartomer CD551) were added. The addition times were three hours for the mixture of monomers and four hours for the ammonium persulfate solution. After one hour stirring at 65° C., the reaction mixture was cooled to 20° C. and diluted in water in an amount of 20% of dry extract.

Polymer (C2) Comprising a Hydrolysable Side Chain of the MPEG 550 Acrylate Type.

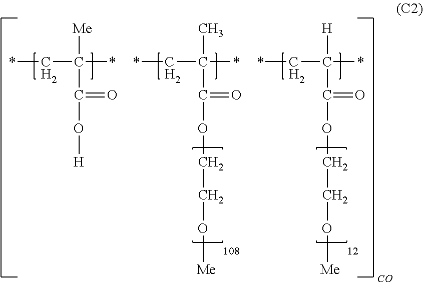

In a glass reactor, equipped with the chemical stirring and a condenser, an aqueous solution (290 g) containing a mixture of sodium methallyl sulfonate (0.99 g) (ALTICHEM) and of sodium metabisulfite (1.49 g) (ALTICHEM) were introduced into the tank bottom. The pH of the mixture was adjusted to 2 by a moderate addition of 96% sulfuric acid (0.9 g) (ALTICHEM). The mixture was maintained with strong stirring and strong nitrogen bubbling for one hour and brought to a temperature of 65° C. Next, and in parallel, an aqueous solution (100 g) containing ammonium persulfate (1.79 g) (ALTICHEM) and a solution containing MPEG 4750 methacrylate (438 g) (CHRYSO), methacrylic acid (0.7 g) (EVONIK) and MPEG 550 acrylate (66.3 g) (Sartomer CD278) were added. The addition times were three hours for the mixture of monomers and four hours for the ammonium persulfate solution. After one hour stirring at 65° C., the reaction mixture was cooled to 20° C. and diluted in water in an amount of 20% of dry extract.

### Example 1

### Synthesis of a Polymer According to the Invention Comprising Hydrolysable Side Chains of Formula (B)

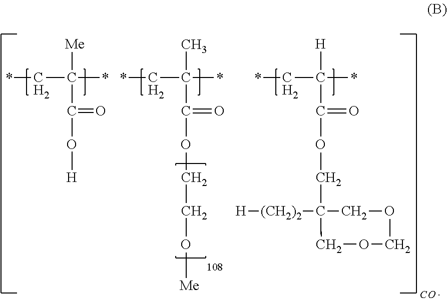

In a glass reactor, equipped with mechanical stirring and a condenser, an aqueous solution (332 g) containing a mixture of sodium methallyl sulfonate (1.3 g) (ALTICHEM) and of sodium metabisulfite (1.2 g) (ALTICHEM) were introduced into the tank bottom. The pH of the mixture was adjusted to 2 by moderate addition of 96% sulfuric acid (0.5 g). The mixture was maintained with strong stirring and strong nitrogen bubbling for one hour and brought to a temperature of 65° C. Next, and in parallel, an aqueous solution (100 g) containing ammonium persulfate (1.4 g) (ALTICHEM) and a solution containing MPEG 4750 methacrylate (520 g) (CHRYSO), methacrylic acid (0.3 g) (EVONIK) and cyclic trimethylolpropane formaldehyde acrylate (43.5 g) (Sartomer SR531) were added.

The addition times were three hours for the mixture of monomers and four hours for the ammonium persulfate solution. After one hour of stirring at 65° C., the reaction mixture was cooled to 20° C. and diluted in water in an amount of 20% of dry extract.

### Example 2

### Use Of the Polymers (A) and (B) as Thinners

The 20% dry extract dispersants (consisting in a mixture of the polymers (A), (B), (C1) or (C2) at 20% in water) were evaluated by measuring mortar workability. The composition of the mortar was that of Table 1:

TABLE 1
Composition of the mortar

| Component | mass (g) |
|---|---|
| CEM I 52.5 N LE HAVRE | 624.9 |
| Limestone filler ERBRAY | 412.1 |
| AFNOR sand | 1350 |
| Fulchiron (correcting sand) | 587 |
| Total water | 375 |

Workability was evaluated by measuring the slump flow diameter (slump flow diameter of the pool formed after flowing) as follows. A bottomless mold with a frusto-conical shape for reproduction at a scale of 0.5 of the Abrams cone (see standard NF 18-451, 1981) of the following dimensions was filled:
Diameter of the upper base circle 5 cm
Diameter of the lower base circle 10 cm
Height 15 cm

After kneading the mortar containing the polymer, the mold was filled, the upper surface of the cone was then leveled and the cone was then lifted vertically and the spreading at 90° was measured with a tape measure. The result of this spreading measurement is the average of two values to within +/−10 mm. The tests were carried out at 20° C. The tests were repeated at the different terms of 5, 30, 60, 90 and 120 minutes along 2 diameters.

The percentages by weight of polymer (A), (B), (C1) or (C2) (dry weight) were adjusted so as to obtain an initial spreading value of 250±20 mm. Thus, respectively 0.5%, 1.2%, 2.2% and 2.5% of polymer (A), (B), (C1) or (C2) by dry weight were used in the mortar. The dose of polymer (B), (C1) or (C2) to be used is therefore larger than the dose of polymer (A), which may be explained by the fact that initially (i.e. before hydrolysis of the ester functions), the polymers (B), (C1) and (C2), comprising hydrolysable monomers, proportionally comprised less carboxylate functions able to bind to the grains of hydraulic binder than polymer (A). The percentages by weight of polymers (C1) and (C2), per dry extract, are of the same order of magnitude, which is explained by the fact that the chemical structures of both of these polymers are close to each other.

The time dependent change in the spreading is illustrated in the appended FIG. 1.

These results show that the maintaining of fluidity over time is clearly improved when the polymer (B) according to the invention is used. Fluidity is maintained for at least two hours after mixing the constituents as a mortar, while it significantly decreases with the three other polymers during the first hour.

### Example 3

### Formulation of the Polymer (B) with the Super Plasticizer CHRYSO®Fluid Premia 180

Example 2 was reproduced by adding a superplasticizer CHRYSO®Fluid Premia 180 to the composition in addition to the polymer (B) according to the invention. The percentages by weight of polymer (B) and of CHRYSO®Fluid Premia 180 were adjusted so as to obtain an initial spreading value of 250 mm±20 mm. Thus 1.1% of the polymer (B) and CHRYSO®Fluid Premia 180 mixture by dry weight were used in the mortar. The dose of the mixture of both polymers is less than that of the polymer (B) used alone (cf. Example 2), which may be explained by a more significant water reducing nature of CHRYSO®Fluid Premia 180 allowing the global dosage to be lowered.

The time-dependent change of the spreading is described in Table 2 below:

TABLE 2
Time-dependent change of the spreading

| | Spreading (mm) |
|---|---|
| | Polymer (B) + |
| Time | CHRYSO ®Fluid Premia 180 |
| (mins) | (1.1%) mixture |
| 5 | 235 |
| 30 | 180 |
| 60 | 165 |
| 90 | 150 |
| 120 | 110 |

### Example 4

### Use of the Polymer (B) for Inhibiting Formation of Cracks in Hardened Hydraulic Compositions

1) Preparation of a Mortar According to the Standard NF 196-1 as of April 2006

The mass proportions were the following: one portion of cement, three portions of standardized sand and a half portion of water (water/cement ratio=0.5). A mixture for three specimens consisted of 450 g of cement and 1,350 g of sand and 225 g of water. The composition of the mortar was that of Table 3.

TABLE 3
Composition of the mortar

| Component | mass (g) |
|---|---|
| CEM I 52.5 N SPLC | 450 |
| AFNOR sand | 1350 |
| Total water | 225 |

The kneading operating procedure was the following:
a) introduction of the water and of the cement in the bowl and optionally of the admixture (polymer (B) (2% by dry weight) or 5-ethyl-5-hydroxymethyl-1,3-dioxane (0.5% or 1% by dry weight)) while taking care in order to avoid any loss of water or cement:
b) as soon as the water and the cement came into contact, the kneader was immediately started at a low speed while starting a stopwatch for the kneading steps. Further, the starting time was recorded to within one minute, as being the “zero time”. After 30 seconds of kneading, all the sand was regularly introduced during the following 30 seconds:
c) the kneader was stopped for 90 seconds. During 30 seconds, all the mortar adhering to the walls of the bottom of the bowl was removed by means of a rubber or plastic scraper and was placed in the middle of the bowl:
d) kneading was resumed at high speed.

2) Making the Specimens and Preserving them Before Removal from the Mold According to the Standard NF 196-1 as of April 2006.

The making of the specimens and their preservation before removal from the mold were performed according to the standard NF EN 196-1.

3) Test Methods for Determining Shrinkage According to the Standard NF P 15-433 February 1994

Shrinkage of the mortar may be directly correlated with cracking, as explained in application EP 1 027 303.

For the shrinkage evaluations, we compared specimens with and without admixture.

The specimens without admixture are used as a control.

The specimens comprising 5-ethyl-5-hydroxymethyl-1,3-dioxane (alcohol (A′) in the application) are used as a comparative example. As a comparison, if it is considered that all the ester functions of the polymer (B) cleave in order to form the 5-ethyl-5-hydroxymethyl-1,3-dioxane alcohol, the specimen comprising 2% by dry weight of the polymer (B) according to the invention comprises 0.7% of 5-ethyl-5-hydroxymethyl-1,3-dioxane alcohol.

The time-dependent change in the shrinkage of the specimens is illustrated in the appended FIG. 2.

A reduction in the shrinkage by 23% for a dosage of 3% biomass of polymer (B) is observed. The reduction in the shrinkage is more significant with 3% biomass of polymer (B) as admixture than with 0.5 or 1% biomass of 5-ethyl-5-hydroxymethyl-1,3-dioxane alcohol.

1. A polymer comprising a main chain comprising units of formula (A): 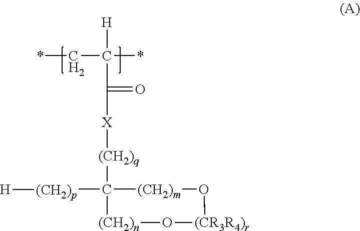
and side chains comprising R₂ groups, wherein:
X represents O or NH,
R₂ represents a group (R₇O)_{z}R₈, with:
R₇ represents a C₂₋₄ C₃ alkylen group,
R₈ represents H, a C₁— C₁₋₂ alkyl, cycloalkyl or aryl, optionally substituted, and
z represents an integer from 1 to 250,
m, n, p and q represent independently an integer comprised between 0 and 3,
r represents an integer comprised between 1 and 3,
R₃ and R₄ represent independently H or a C₁-C₆ alkyl group.

2. The polymer according to claim 1, comprising units of the following formulae (A) and (B): 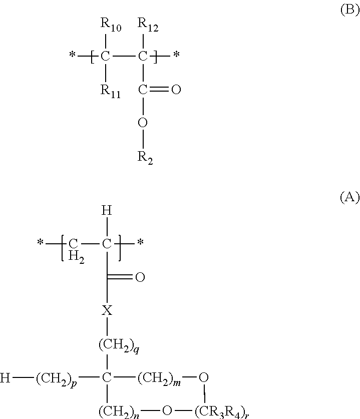
wherein:
X, m, n, p, q, r, R₂, R₃ and R₄ are as previously defined,
R₁₀, R₁₁ and R₁₂ represent independently a group selected from H, alkyl, —COO-alkyl, COOR₂ and COO(M)_{1/c} wherein M represents a cation and C is an integer representing the valency of cation M.

3. The polymer according to claim 2, comprising the units of the following formulae (A), (B) and (C): 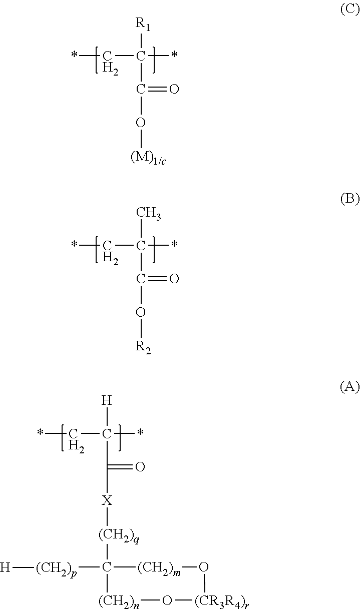
wherein:
X, m, n, p, q, r, R₂, R₃ and R₄ are as previously defined,
R₁ represents H or a methyl,
M represents H or a cation and c is an integer representing the valency of the cation M.

4. The polymer according to claim 3, of the following formula (1): 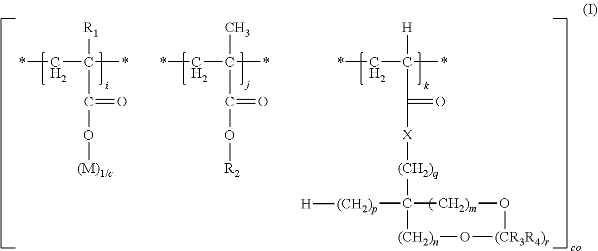
wherein:
i, j and k represent independently an integer from 1 to 1,000,
X, M, c, R₁, R₂, R₃, R₄, m, n, p, q and r are as previously defined.

5. The polymer according to claim 1, wherein:
q represents 0 or 1, and/or
p represents 0, 1 or 2, and/or
m represents 1, and/or
n represents 1, and/or
r represents 1.

6. The polymer according to claim 1, wherein R₃ and R₄ represent independently H, a methyl or an ethyl, R₃ and R₄ preferably representing H.

7. The polymer according to claim 4, wherein:
the ratio i/(i+j+k) is from 0.01 to 0.8, and/or
the ratio j/(i+j+k) is from 0.01 to 0.65, and/or
the ratio k/(i+j+k) is from 0.05 to 0.90.

8. The polymer according to claim 1, comprising from 2 to 10% by mass of a unit of formula (A).

9. The polymer according to claim 1, with a weight molecular mass from 5,000 to 500,000 grams/mol.

10. The polymer according to claim 1 wherein the polymer has the following formula (I′): 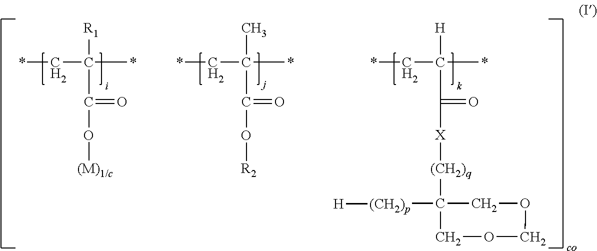
wherein:
i, j and k represent independently an integer from 1 to 1,000,
R₁ represents H or a methyl,
M represents H or a cation and c is an integer representing the valency of the cation M, and
X, R₂, p and q are as previously defined.

11. A method for preparing a polymer according to claim 2, comprising a step a1) for copolymerization of a monomer of the following formula (XII): 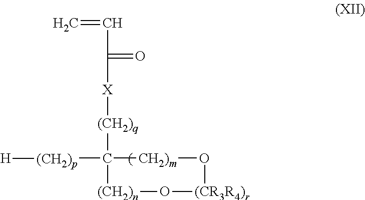
wherein X, R₃, R₄, m, n, p, q and r are as previously defined,
with a monomer of the following formula (XI′): 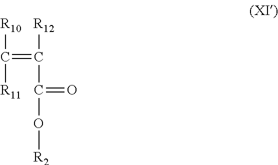
wherein R₂, R₁₀, R₁₁ and R₁₂ are as previously defined.

12. The preparation method according to claim 11, comprising a step (A1) for copolymerization of monomers of the following formulae (X), (XI) and (XII): 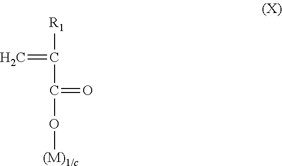
wherein R₁ represents H or a methyl, M represents H or a cation and c is an integer representing the valency of the cation M: 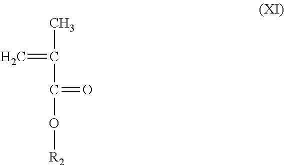
wherein R₂ is as previously defined, 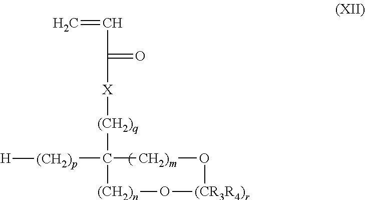
wherein X, R₃, R₄, m, n, p, q and r are as previously defined.

13. A method for preparing a polymer according to claim 2, comprising the steps of:
a2) copolymerizing a monomer of the following formula (XXII): 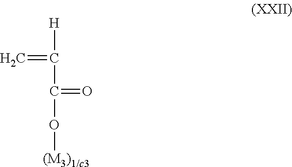
wherein M₃ represents H, a metal cation or an ammonium cation and C₃ is an integer representing the valency of the cation M₃,
with a monomer of the following formula (XXI′): 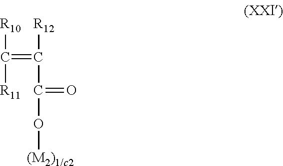
wherein R₁₀, R₁₁ and R₁₂ are as previously defined, M₂ represents H, a metal cation or an ammonium cation and C₂ is an integer representing the valency of the cation M₂,
b) esterification of the polymer obtained during step a2) with compounds R₂-GP₁ and 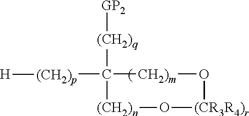
wherein R₂, R₃, R₄, m, n, p, q and r are as previously defined and GP₁ and GP₂ are leaving groups, especially selected independently from —OH, —OTs, OMs, —Cl and —Br.

14. The preparation method according to claim 13, comprising the steps of:
a2) copolymerizing monomers of the following formulae (X), (XXI) and (XXII): 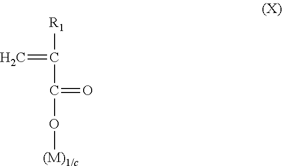
wherein R₁ represents H or a methyl, M represents H or a cation and c is an integer representing the valency of the cation M, 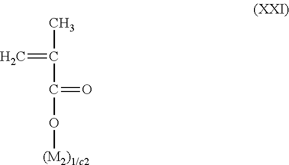
wherein M₂ represents H, a metal cation or an ammonium cation and c2 is an integer representing the valency of the cation M₂, 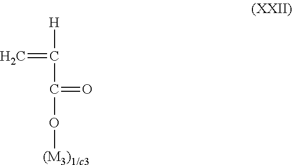
wherein M₃ represents H, a metal cation or an ammonium cation and c3 is an integer representing the valency of the cation M₃,
in order to obtain a polymer (XXV) comprising units of the following formulae: 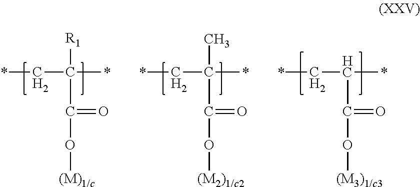
b) esterification of a polymer (XXV) with compounds R₂— GP₁ 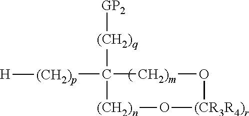
wherein R₂, R₃, R₄, m, n, p, q and r are as previously defined and GP₁ and GP₂ are leaving groups, especially selected independently from —OH, —OTs, OMs, —Cl and —Br.

15. Process for improving maintenance of fluidity of hydraulic compositions and inhibiting the formation of cracks in hardened hydraulic compositions, which comprises adding an effective amount of the polymer as defined in claim 1 to said compositions.

16. A thinner for hydraulic compositions comprising the polymer as defined in claim 1 in solution and a solvent, especially in an aqueous solution, preferably comprising from 5 to 50% by weight of said polymer, based on the total weight of the solution.

17. A hydraulic composition comprising:
a polymer as defined in claim 1,
a hydraulic binder,
a granulate, and
water.

18. The hydraulic composition according to claim 17, wherein the hydraulic composition is concrete, mortar or plaster.
